(19) United States
(12) Patent Application Publication
(10) Pub. No.: US 2001/0007390 A1
(43) Pub. Date: Jul. 12, 2001

(54) Powered mobility aid

(76) Inventor: Marty S. Klaiber, Colorado Springs, CO (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 09/790,928

(22) Filed: Feb. 22, 2001

Related U.S. Application Data
(63) Continuation-in-part of application No. 09/150,652, filed on Sep. 10, 1998, now Pat. No. 6,183,002.

(51) Int. Cl. B62B 7/00; B60K 1/00

(52) U.S. Cl. 280/647; 180/65.1

(57) ABSTRACT

A foldable powered mobility device includes an actuator for providing an output signal in response to movement of the actuator by a user of the device. A central processing unit receives the signal correlating to the actuator angle of articulation and the direction of articulation and creates a series of signals to independently drive motors, thereby controlling the speed, direction and travel of the mobility aid to that desired by the operator. The central processing unit also receives signals from tachometers monitoring the speed and direction of travel for each wheel. The central processing unit creates an independent signal to control the speed and direction of travel of each of the right and left drive motors. By independently driving each drive motor, the mobility aid is powered in the desired direction at the desired speed.

### RELATED APPLICATIONS

The invention is an improvement upon the invention disclosed and claimed in co-pending application Ser. No. 09/150,652, filed on Sep. 20, 1998 and commonly owned by the Assignee of this application. The subject matter of the '652 application is expressly incorporated herein by reference.

### FIELD OF THE INVENTION

This invention relates generally to wheelchairs. More particularly, this invention relates to powered mobility aids that are lightweight, foldable and portable.

### BACKGROUND OF THE INVENTION

The current mobility assistance market is served by over 450 models of mobility aids produced by more than 150 manufacturers. The four categories of mobility aids currently available include: (1) standard wheelchairs (manual propulsion); (2) ultralight wheelchairs (manual propulsion); (3) three and four wheel scooters (powered propulsion); and (4) powered wheelchairs.

Standard wheelchairs are the conventional, folding wheelchairs which can be seen in hospitals, airports, and shopping malls. They typically come in two models: self propelled, with large wheels which a passenger uses to propel themselves, and “Attendant” models, which have smaller wheels and are meant to be pushed by another person. Both types will typically fold sideways to make transport easier. Standard wheelchairs are typically priced low enough such that health insurance reimbursement is easily obtained for mid-range models based on a physician's prescription. Key shortcomings of standard wheelchairs include their unattractive, orthopedic product designs, and the fact that either physical exertion or an attendant is required to propel the chair.

Ultralight wheelchairs, the newest, most visible products, are currently receiving strong publicity. They are built out of exotic alloys and employ radical new designs in order to be quick and agile. Their reduced weight makes them easy to use and lift, but the frames will not typically fold. They typically are more expensive than standard wheelchairs, and are targeted toward younger, more active users. As a result of their higher cost, health insurance reimbursement is typically available only for an individual with a full-time need and only with a physician's prescription. Key shortcomings of the ultralight wheelchairs include the fact that manual exertion is required to move the chair, the orthopedic nature of the design, and the high price of such chairs limits their availability as a secondary or discretionary aid purchase.

Scooters are built in three and four wheel configurations and come closest to the industry's notion of a “consumer product”, mitigating, to a large degree, the “handicapped” stigma associated with wheelchairs. Scooters are designed with thorough attention to aesthetics, are attractive in appearance, and perceived as fun, liberating and free-spirited in use. They are robust enough to function in cross-country and non-access-ready environments. While built to serve the needs of severely disabled individuals able to obtain heath insurance reimbursement, scooters are also purchased, on a non-reimbursed basis, by individuals who have mobility difficulties which are not severe enough to qualify for reimbursement.

The most widely sold scooter models cost between three and five times the cost of standard wheelchairs, and weigh around 90 pounds without their batteries. Obtaining health insurance reimbursement for scooters (or any other powered mobility aid) is much more difficult than for manual wheelchairs; it typically requires an acute need (such as full-time impairment), several physicians' prescriptions, and ongoing and consistent follow up by physical therapists or equipment dealers. Key shortcomings of scooters include their high prices limiting their discretionary purchase acceptability, their large size making them cumbersome when used indoors or in social situations, and their heavy weight making scooters difficult to transport, typically requiring disassembly or a van.

Powered wheelchairs are becoming more sophisticated and robust with each design iteration. They are currently increasing in weight and cost as the frame designs, mechanicals, and electronics increase in complexity. Since they are designed exclusively for the needs of severely disabled individuals, they are heavy duty medical appliances, which can handle a wide variety of non-access-ready environments and can overcome significant environmental obstacles. They are currently purchased almost exclusively with heath insurance reimbursement, often require the close involvement of a team of healthcare professionals (physicians, physical therapists, wheelchair specialists) to fulfill prescriptive requirements and conduct a customized “fitting” of the wheelchair, and are generally used by individuals with only the greatest degree of impairment or disability. As a powered mobility aid, the procedures and qualification for health insurance reimbursement are similar in nature, but more extensive than those required for scooters. Powered wheelchairs will typically cost between four to eight times the cost of standard wheelchairs, and weigh between 80 to 150 pounds (without batteries). Weight has not typically been a consideration for manufacturers of powered wheelchairs, since severely disabled users will normally have modified their lifestyles, transportation means and living environments to accommodate their needs. The key shortcomings of powered wheelchairs include their high price as they are specialized medical applicants, their heavy weight and large sizes which make them cumbersome to transport, and their unattractive, orthopedic appearance.

Each of the products discussed above is, by and large, derived from the healthcare industry. Such products are largely medical and orthopedic appliances and, because of their cost, appearance and cumbersomeness, are most suited to individuals with acute mobility difficulties who require full time mobility assistance. They are designed largely for functional use following a trauma and as such are (i) designed for use in all environments (including those that are not handicap access-ready); (ii) unappealing, heavy steel and chrome orthopedic appliances; and (iii) heavy and unwieldy which make them difficult or impossible to operate and transport.

A final issue surrounding current products relates to their prescriptive nature and the difficulty of obtaining health insurance reimbursement. Standard wheelchairs are easily reimbursed based on a generally prescribed need. Ultralight wheelchairs can be reimbursed if the need is full-time or more specialized and this need is reflected in the prescription. For powered aid reimbursement, either scooters or wheelchairs, the difficulty increases dramatically. Often several physicians will need to support the prescription process, and physical therapists or equipment specialists will need to follow up with the agencies. In all cases, health insurance will only reimburse the cost of a single mobility aid. The costs for any secondary or discretionary aids that may be desired (such as a light wheelchair for transport and use in place of a scooter) are borne solely by the customer.

There are several common attributes that wheelchair and scooter users desire. Each of the products described above meet some, but not all, of these criteria. As Table I shows, consumers are forced to make substantial compromises when selecting from one of the currently available products. A “WA” in the table below indicates that the criteria “well-addressed” by the product, and a “PA” indicates that the criteria is “partially addressed” by the product.

TABLE I
Current Mobility Aids & Characteristics

| | | | | Easy-To- | Non- | | | |
|---|---|---|---|---|---|---|---|---|
| | Affordable | Transportable | Comfortable | Use | Orthopedic | Unobtrusive | Powered | All Terrain |
| Standard | WA | WA | WA | PA | | | | |
| Wheelchairs | | | | | | | | |
| Ultralight | | WA | WA | PA | | WA | | PA |
| Wheelchairs | | | | | | | | |
| Powered | | | WA | | | | PA | PA |
| Wheelchairs | | | | | | | | |
| Scooters | | | WA | PA | WA | | PA | PA |

The present invention is designed to satisfy the needs of individuals who are not dependent on a full-time mobility aid. It is targeted towards those individuals who experience pain, difficulty or tire easily when walking. As such, it is an object of the present invention to provide an affordable mobility aid for part-time discretionary assistance. That is, for use by individuals who are able to walk unaided or with some mobility assistance, but experience pain or tiredness when conducting their daily routines around their home, work, community or shopping centers.

It is further a object of the present invention to provide a mobility aid that folds compactly, is lightweight and highly transportable. Thus, as discussed more fully below, the present invention incorporates a frame that is sturdy and rigid when in use, but which can be quickly and compactly folded for transport. Other powered wheelchairs will collapse to a limited degree, but the present invention folds to a small, flat, lightweight, package which can be easily lifted and placed into a car trunk or back seat.

It is a still further object of the present invention to provide a battery powered mobility aid that has improved power retention and improved operating controls for driving the mobility aid at variable speeds and maneuvering the mobility aid in varying directions and around obstacles.

These and other objects and advantages of the invention will become more fully apparent from the description and claims which follow or may be learned by the practice of the invention.

### SUMMARY OF THE INVENTION

The present invention is directed to improvements in a powered mobility aid having a seat and a plurality of wheels. A plurality of legs are provided for supporting the seat. Each of the legs is positioned between the seat and one of the wheels. Reinforcing members and cross beams are positioned between the legs to provide reinforcement to the legs during use. The seat of the powered mobility aid includes a seat bottom and a seat back pivotally coupled to the seat bottom. The seat back is movable between a folded position and an unfolded position. The seat bottom has a back end formed from a first curved shape, and the seat back has a bottom end formed from a second curved shape. The first curved shape of the seat bottom is sized to mate the second curved shape of the seat back when the seat back is in the unfolded position.

In accordance with the present invention, the foldable powered mobility device includes an actuator for providing at least one actuator output signal in response to movement of the actuator by a user of the device. The actuator is movable from a centered at-rest position in any direction within a 360° cartesian plane, which direction correlates to the direction in which the operator wishes to proceed. The central processing unit (CPU) receives the signal correlating to the actuator angle of articulation and the direction of articulation and creates a series of signals to independently drive the motors, thereby controlling the speed and direction of travel of the mobility aid to that desired by the operator.

The central processing unit (CPU) while receiving the signal from the actuator also receives signals from quadrature encoders which serve as tachometers monitoring the speed and direction of travel for each wheel. The CPU then creates an independent signal to control the speed and direction of travel of each of the right and left drive motors. By independently driving each drive motor, the mobility aid is powered in the desired direction at the desired speed.

### BRIEF DESCRIPTION OF THE DRAWINGS

In order that the manner in which the above-recited and other advantages and objects of the invention are obtained and can be appreciated, a more particular description of the invention briefly described above will be rendered by reference to a specific embodiment thereof which is illustrated in the appended drawings. Understanding that these drawings depict only a typical embodiment of the invention and are not therefore to be considered limiting of its scope, the invention and the presently understood best mode thereof will be described and explained with additional specificity and detail through the use of the accompanying drawings.

FIG. 1 is a side view of a lightweight, foldable powered mobility aid in accordance with a preferred embodiment of the present invention.

FIG. 2 is a partial front view of the powered mobility aid of FIG. 1.

FIG. 3 is a partial back view of the powered mobility aid of FIG. 1.

FIG. 4 is a side view of the powered mobility aid of FIG. 1 in its fully folded position.

FIG. 5 is an enlarged detail view showing the interlock between a leg member and the track locking member of the powered mobility aid of FIG. 1

FIG. 6 is an enlarged detail view showing the release of the interlock between a leg member and the track locking member of the powered mobility aid of FIG. 1.

FIG. 7 is a detail view of the locking member and its release member of the powered mobility aid of FIG. 1.

FIG. 8 is an isolated detail view of the locking member shown in FIG. 7.

FIG. 9 is a detail view of the rear wheels, drive motors, brakes and drag wheels of the powered mobility aid of FIG. 1.

FIG. 10 is a side view of the powered mobility aid of FIG. 1 in its folded position being pulled on its drag wheels.

FIG. 11 is a block diagram of the drive system of the powered mobility aid of the present invention.

FIGS. 12, 12A and 12B are an electrical schematic of the drive control system of the powered mobility aid of the present invention.

FIG. 13 is a schematic map of the transition in the power ratio between the right and left drivers as actuated by the position of the joystick actuator.

FIGS. 14A and 14B are graphs representing the transition in the power ratio between the right and left drivers in transition zone A and transition zone B, respectively.

FIG. 15 is a schematic map of the velocity contours for the joystick actuator of the present invention.

### DESCRIPTION OF THE PREFERRED EMBODIMENTS

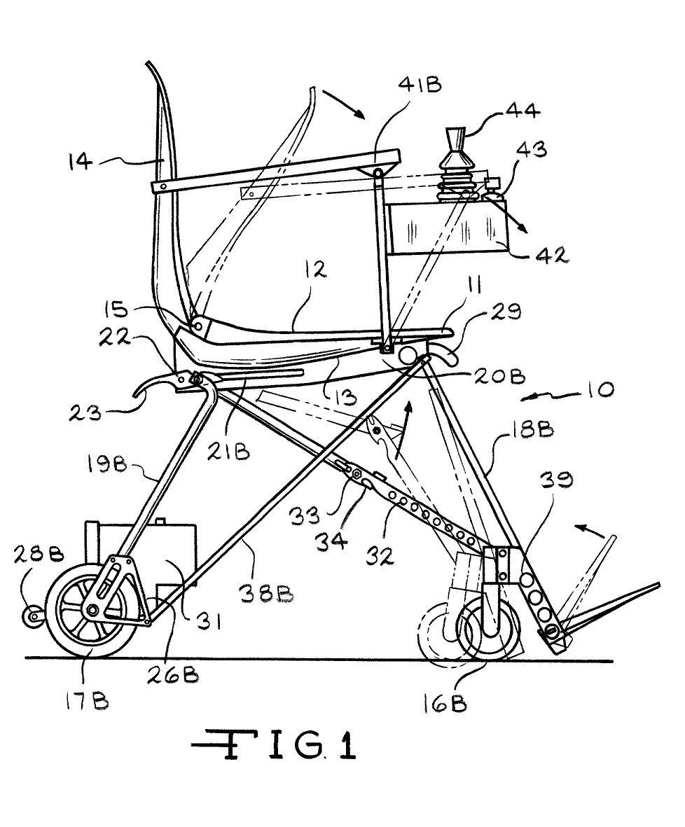

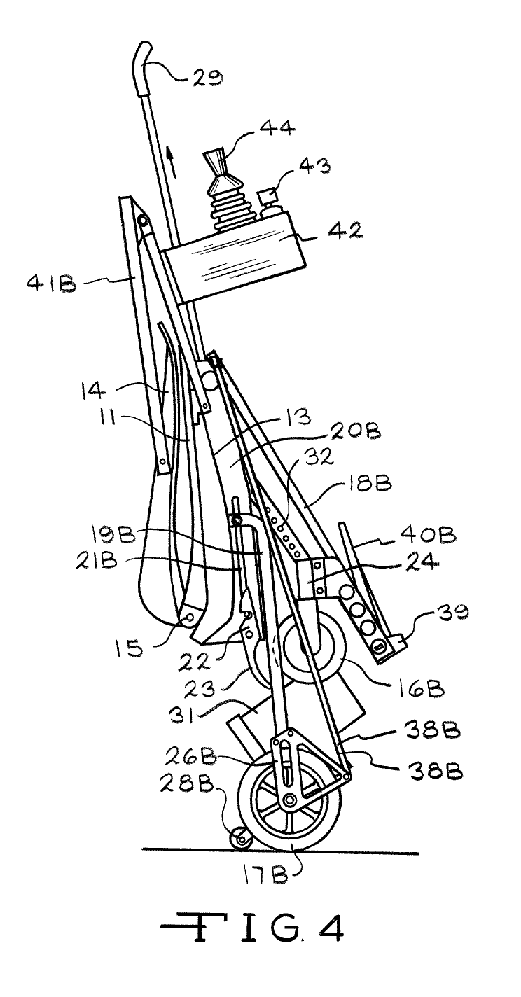

Referring now to FIGS. 1-4, a lightweight, foldable powered mobility aid 10 is shown in an upright position (FIGS. 1-3) and a fully folded position (FIG. 4). The mobility aid 10 has a seat bottom 11 having an upper surface 12 and a lower surface 13. A seat back 14 is pivotally coupled to the seat bottom 11 at hinge 15. When the powered mobility aid 10 is folded, the seat back 14 pivots on the hinge 15 toward the upper surface 12 of the seat bottom, as shown in FIG. 4 and in ghost in FIG. 1. Two front wheels 16A and 16B and two rear wheels 17A and 17B are provided for rolling the powered mobility aid along the ground surface. The mobility aid further includes two front legs 18A and 18B, each leg respectfully engaged with a front wheel 16A and 16B and with the lower surface 13 of the seat bottom 11. Rear legs 19A and 19B are respectfully engaged with the rear wheels 17A and 17B and the lower surface 13 of the seat bottom 11.

The lower surface 13 of the seat bottom 11 includes a pair of track members 20A and 20B integrally formed with the lower surface 13 of the seat bottom 11, in parallel and spaced relationship and extending from a position proximate the rear of the seat bottom to a location proximate the front of the seat bottom. The front legs 18A and 18B are pivotally fixed, in the embodiment shown, proximate the respective front edge of the track members 20A and 20B. The rear legs 19A and 19B are engaged with the respective track members 20A and 20B and positioned in slots 21A and 21B for sliding movement therein. As shown in FIG. 4, when the powered mobility aid is folded, the front legs 18A and 18B pivot inward toward the seat bottom 11 and the rear legs 19A and 19B slide in the slots 21A and 21B of the track members 20A and 20B and pivot in a rearward direction from the seat bottom 11.

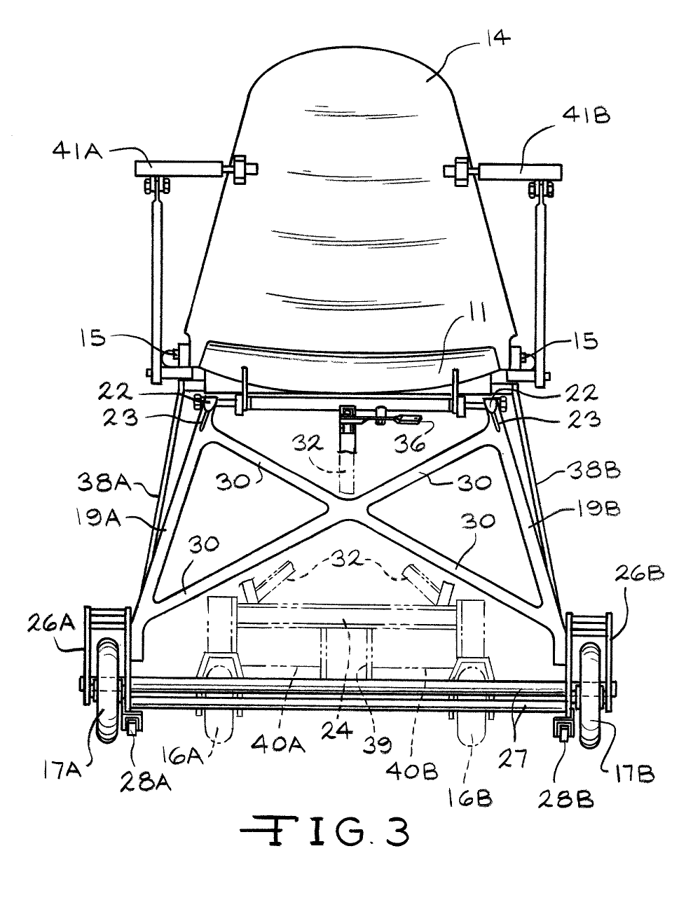

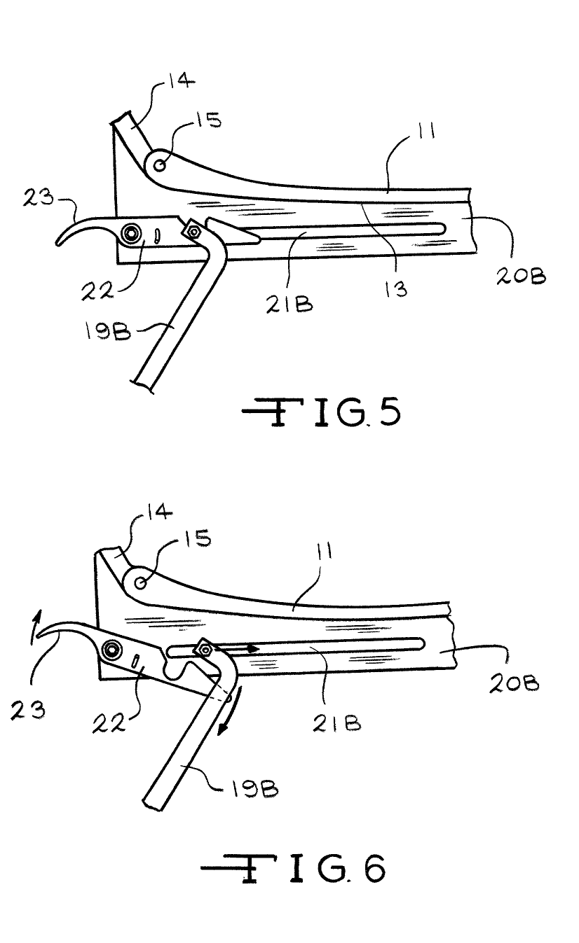

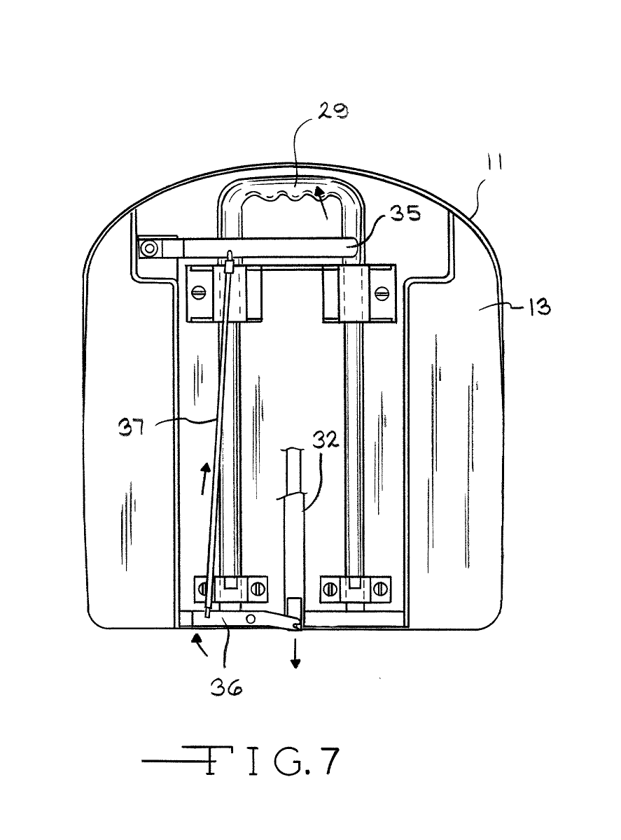

As shown in FIGS. 1 and 3 and in detail in FIGS. 5 and 6, a track locking member 22 is pivotally engaged with the track members 20A and 20B proximate the rearward ends of the slots 21A and 21B. When the powered mobility aid 10 is in its unfolded position, the upper end of each rear leg 19A and 19B is locked in the unfolded position by the track locking member 22 as shown in FIG. 5. When it is desired to fold the powered mobility aid, the track locking member 22 is disengaged from the upper end of each rear leg 19A and 19B by pulling upward on the handle 23 as shown in FIG. 6. Once the rear legs 19A and 19B are released from the track locking member 22, the upper ends of the rear legs 19A and 19B are free to slide in the slots 21A and 21B, thus facilitating the folding of the wheelchair as shown in FIG. 4.

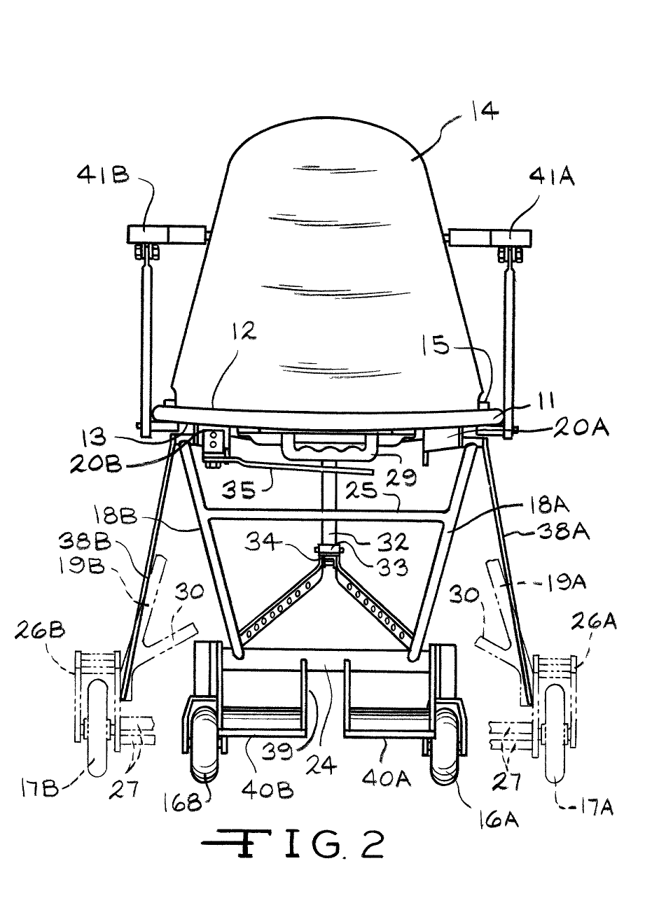

Referring now to FIG. 2, a front reinforcing member or cross beam 24 is fixed between the two front legs 18A and 18B at a location proximate the respective distal ends of each of the two front legs 18A and 18B. A second front reinforcing member 25 extends between the two front legs 18A and 18B at a location spaced between the front reinforcing member or cross beam 24 and the lower surface 13 of the seat bottom 11.

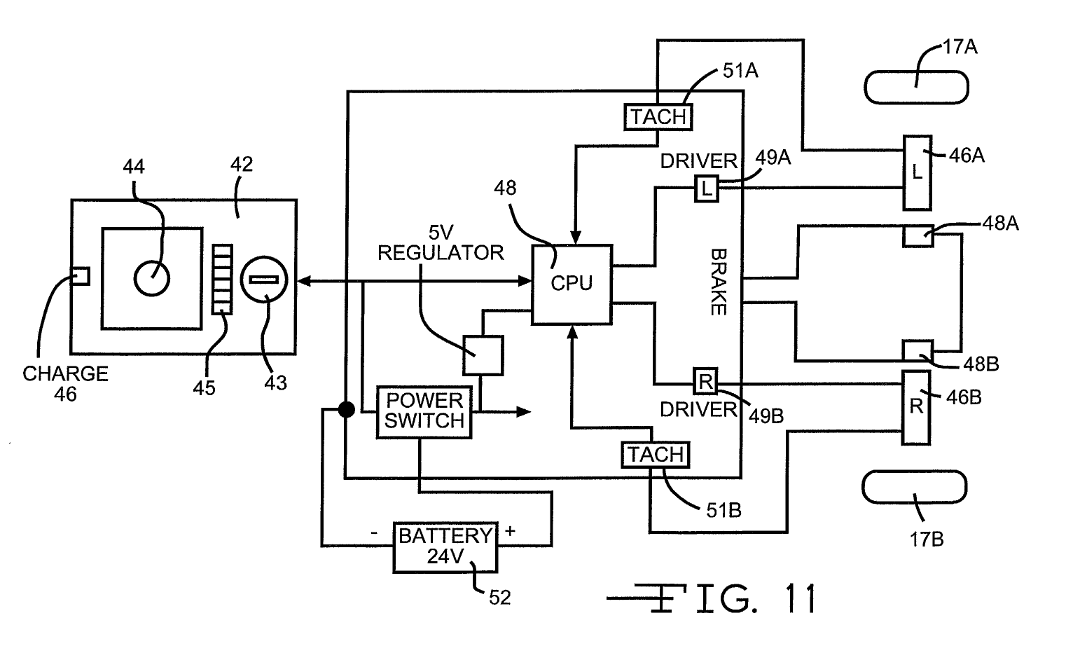

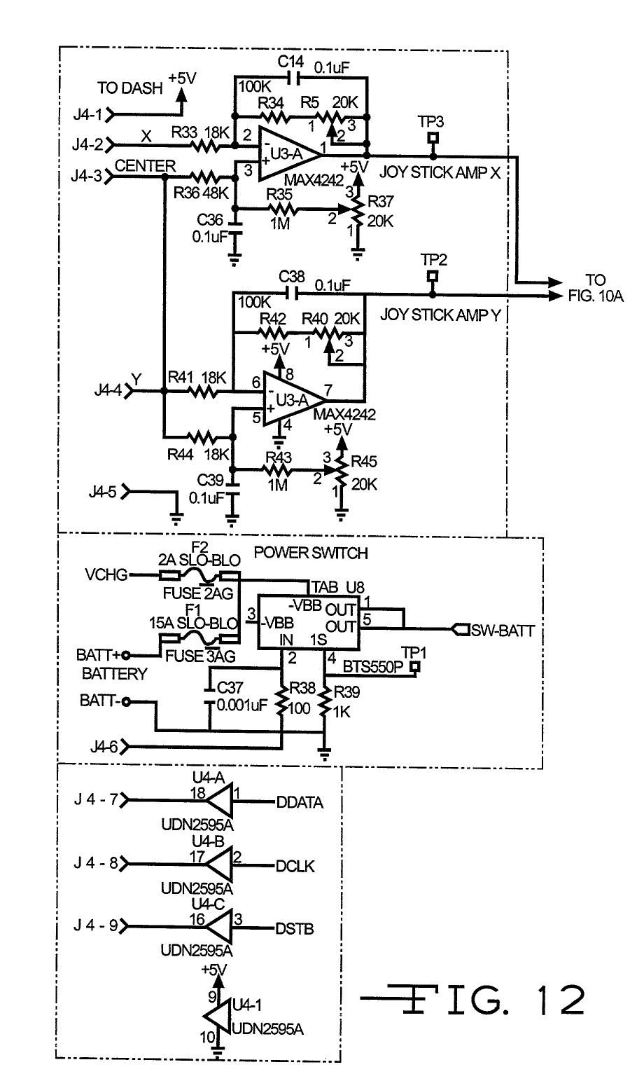

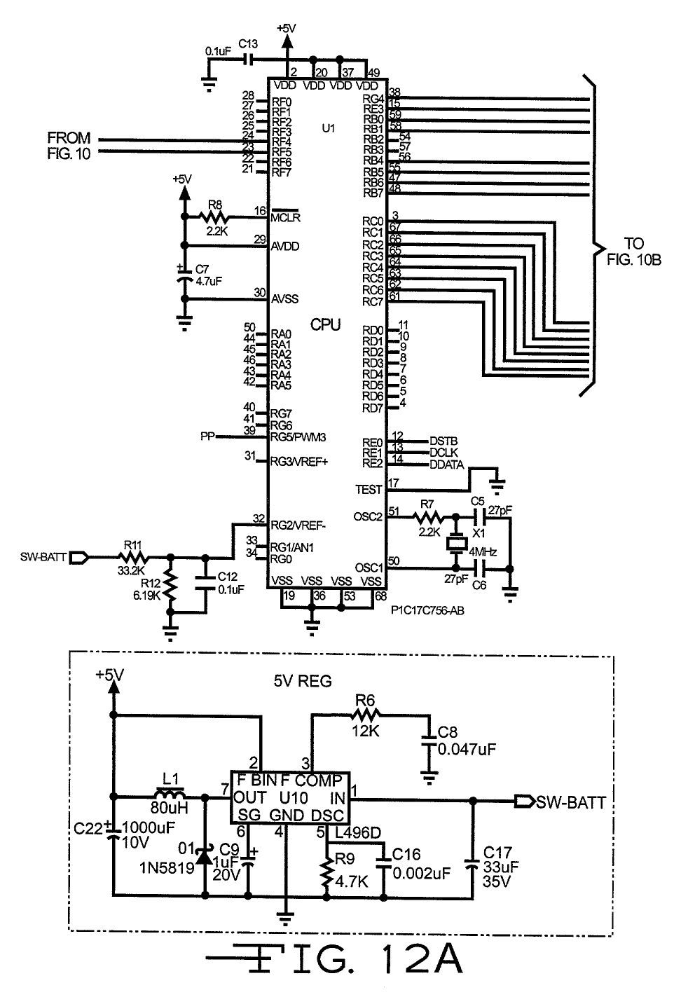

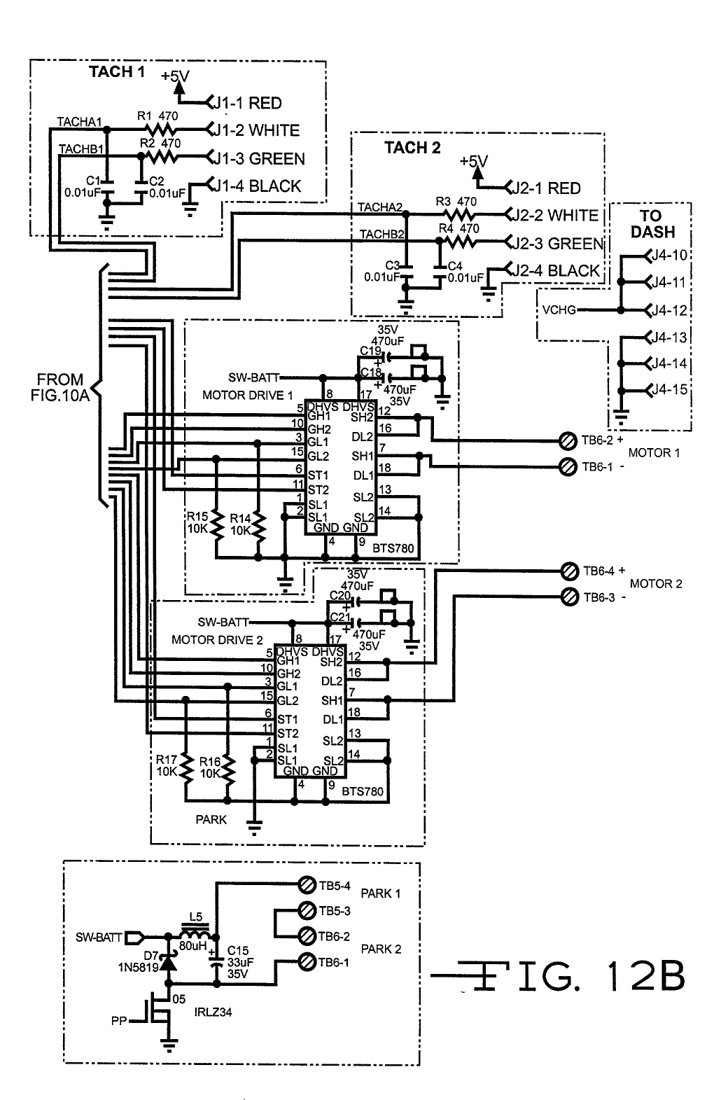

Referring to FIGS. 1-4, a pair of rear wheel frames 26A and 26B which partially enshroud the rear wheels 17A and 17B are fixed to the distal ends of the rear legs 19A and 19B. The rear wheel frames 26A and 26B are interconnected by at least one, and preferably two, cross beams 27 which extend therebetween. The cross beams 27 and wheel rear frames 26A and 26B act to stabilize the rear wheels 17A and 17B and prevent the rear wheels 17A and 17B from twisting or torquing during operation. Also attached to the rear wheel frames 26A and 26B are drag rollers 28A and 28B which are useful when the powered mobility aid is in the folded position. Handle 29 is slideably engaged with the lower surface 13 of the seat bottom 11 and when the handle 29 is in the extended position as shown in FIG. 4, the mobility aid can be pulled by the user as shown in FIG. 10. Further, the drag wheels 28A and 28B can be used in combination with the rear wheels 17A and 17B to support the folded powered mobility aid 10 in an upright position as shown in FIG. 4.

At least one rear reinforcing member 30 extends between the two rear legs 19A and 19B to provide further structural support to the rear legs 19A and 19B. The battery pack 31 is preferably positioned on at least one of the rear cross beams 27.

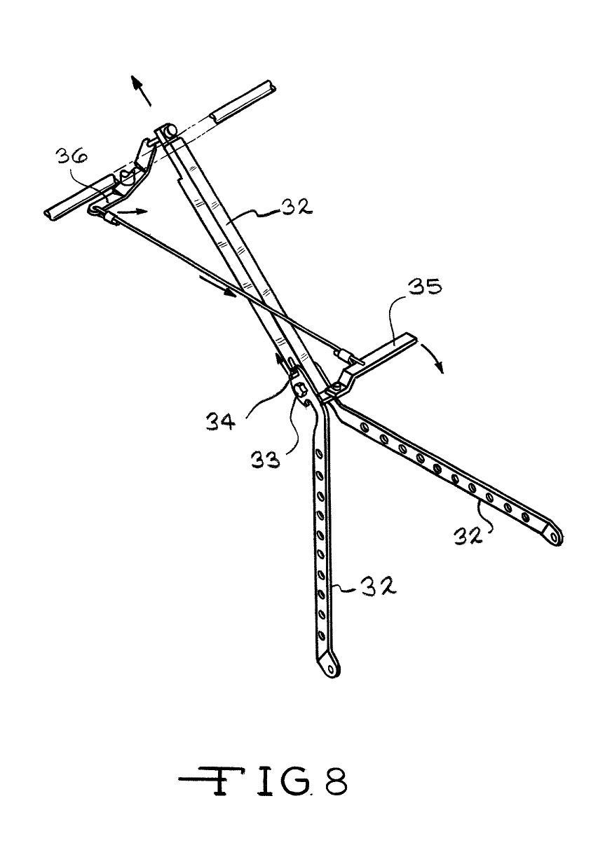

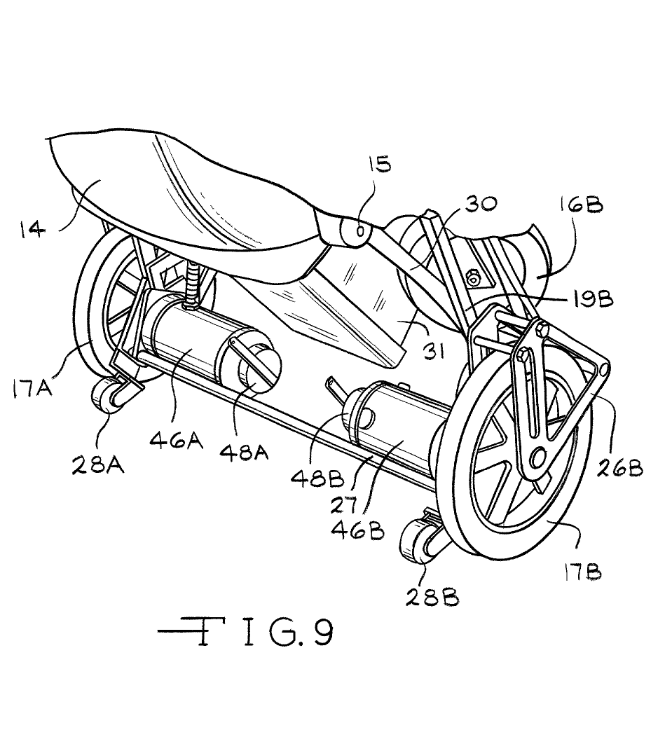

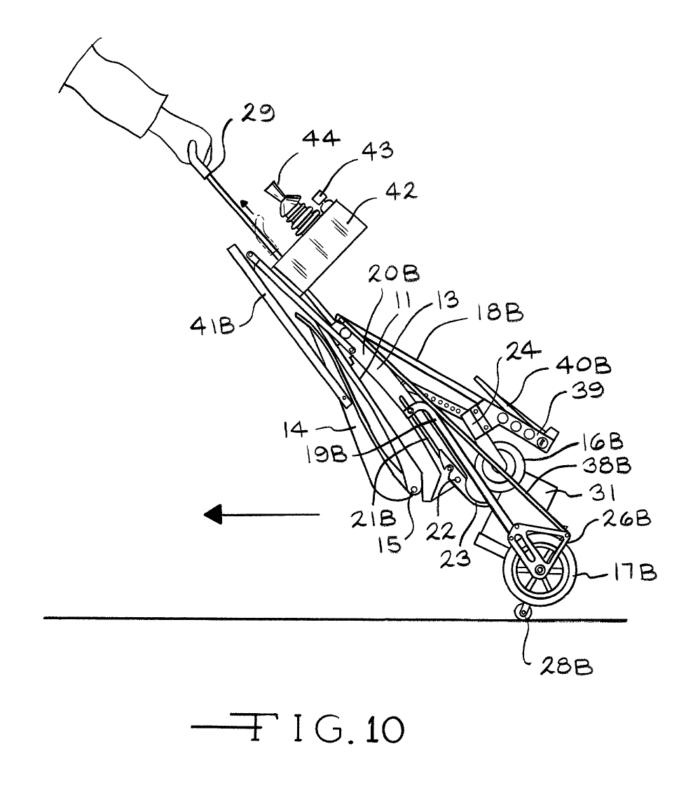

A foldable strut 32 extends between the track locking member 22 and the front reinforcing member 24. The foldable strut 32 includes a hinge 33 and locking mechanism 34 proximate the center of the strut 32. The locking mechanism 34 is operative as shown in FIGS. 7 and 8 by handles 35, 36 which are engaged by tie rod 37. A pulling force on handle 35 causes a reactive force through tie rod 37 to handle 36 which disengages the locking mechanism 34, thereby allowing the strut 32 to fold about its hinge 33. The locking mechanism 34 is designed to lock the strut in either (1) a fully extended position as shown in FIGS. 1 and 2, or (2) a completely folded position as shown in FIG. 4.

Finally, to further reinforce the structural rigidity of the front legs 18A and 18B and rear legs 19A and 19B, at least one side reinforcing member 38A and 38B is positioned between each set of front legs 18A and 18B and rear legs 19A and 19B.

A foot rest support member 39 is rigidly affixed to the front reinforcing member 24. A pair of foot supports 40A and 40B are pivotally mounted to the foot rest support member 39. During operation of the powered mobility aid 10, the foot supports 40A and 40B are preferably placed in their unfolded position as shown in FIG. 1. During folding of the mobility aid, the ends of the foot supports 40A and 40B are pivoted upward toward the support member 39 as shown in ghost in FIG. 1 and in final folded position in FIG. 4. Adjustment screws (not shown) are preferably provided for adjusting the height of the foot supports 40A and 40B in order to customize the powered mobility aid 10 for users of different heights.

The powered mobility aid 10 further includes arms 41A and 41B which are pivotally engaged between the seat bottom 11 and seat back 14. An actuator assembly 42, which includes an on/off switch 43, speed and direction actuator 44 and battery discharge light 45, as shown schematically in FIG. 11 is fixed to one of the arms 41. Further, a charging port 46 for use in recharging the battery is preferably included in the actuator assembly 42.

Referring now to the block diagram of FIG. 11 and the electrical schematics of FIGS. 12, 12A and 12B, the power and directional control operation for the powered mobility aid 10 is shown in accordance with the preferred embodiment of the invention. The mobility aid is powered by a 24 volt battery pack 31. Independently operating motors 46A and 46B are respectively engaged with the left rear wheel 17A and right rear wheel 17B. Electric brakes 48A and 48B are attached to each of the drive motors 46A and 46B and are designed to become engaged when there is no power directed to the respective motor 46A and 46B. The motors and brakes are controlled by the central processing unit 48 which directs the left and right drivers 49A and 49B to input power to the left and right motors 46A and 46B based upon signals received from the actuator 44 and quadrature encoders 51A and 51B which serve as tachometers. The quadrature encoders 51A and 51B provide speed and direction information to the CPU 48.

The joy stick actuator 44 provides three output signals, namely an X (+/−) signal, a Y (+/−) signal and a reference signal. The X (+/−) signal and the Y (+/−) signal represent the X-Y coordinates on a cartesian plane which corresponds to the “angle” and “direction” at which the joy stick is positioned at any given moment in time. When no force is applied to the joy stick actuator 44, the joy stick is preferably aligned in a vertical position, such that it is straight up and down. When the joy stick is aligned in the straight up and down position, the “angle” of the joy stick relative to the vertical axis is zero. As a user imparts an actuation force to the joy stick, the angle of displacement between the vertical axis and the joy stick increases and velocity of the mobility aid increases. The direction of displacement of the joystick controls the direction of travel of the mobility aid. The joy stick 44 can thus be actuated by a user in any direction within a range of possible angles of displacement in order to vary and control the speed and direction of travel of the mobility aid.

The signals received from the joy stick actuator 44 and signals received from the quadrature encoders 51A and 51B are provided to the central processing unit (CPU) 48 which in turn generates signals to be provided to the right motor driver 49B and left motor driver 49A. The signals provided to the drivers 49A and 49B will determine whether the motors 46A and 46B should drive in a forward or reverse direction and the speed at which the motors drive. Thus, the mobility aid is powered in the forward or reverse direction or the wheels are powered in differing directions and/or at different speeds to effect turning and directional control of the mobility aid.

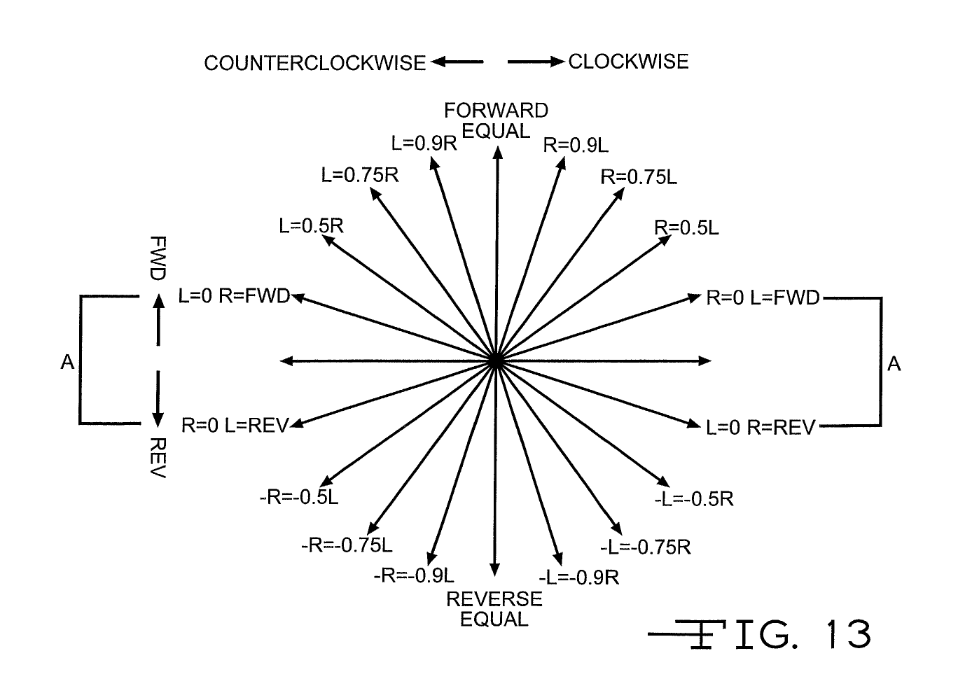

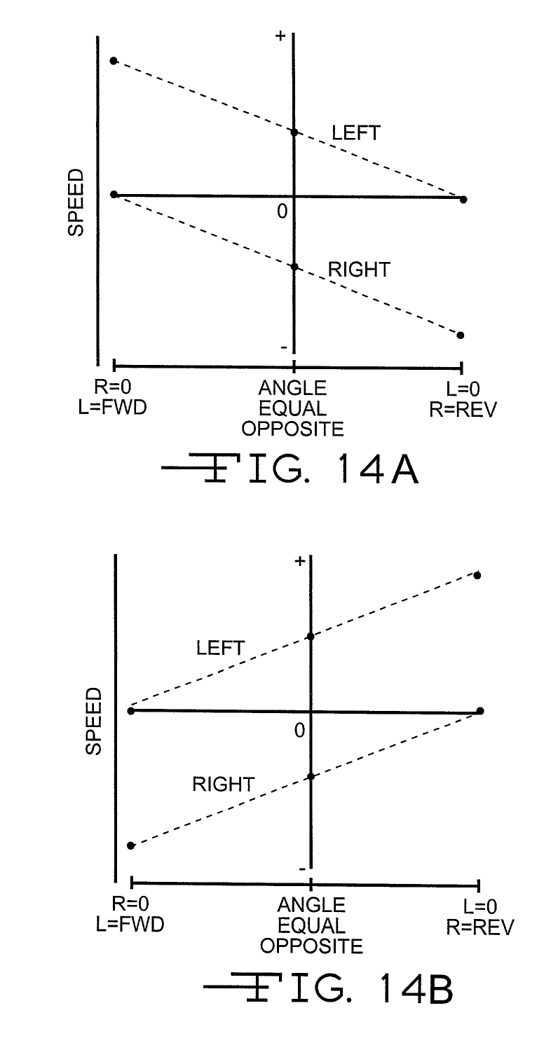

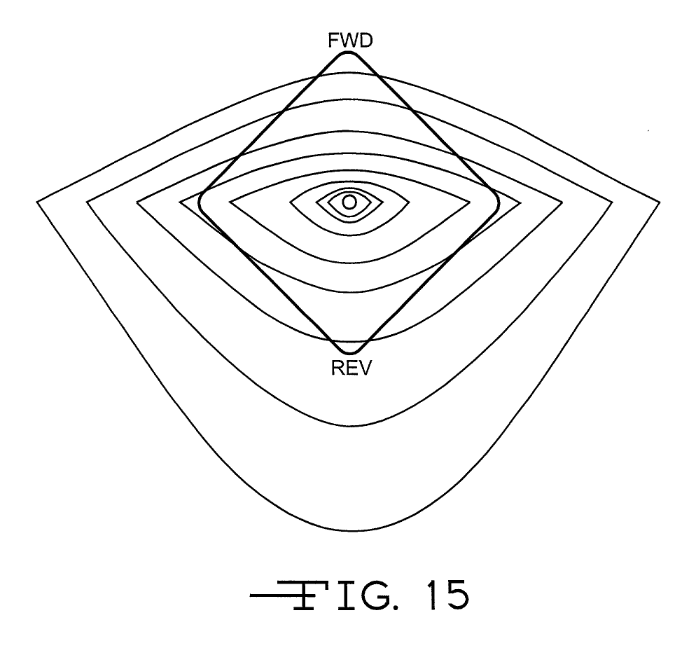

The power signals that the central processing unit 48 generates for the right and left motor drivers 49B, 49A are schematically demonstrated in FIGS. 13-15. Viewing FIG. 13, the cartesian plane in which the joystick actuator 44 operates is shown with vectors designating the right driver R and the left driver L and their transition ratios relative to a position of the joystick actuator. The Y axis vectors represent both drivers R, L being equally powered in either the forward direction or the reverse direction. The mobility aid will thus travel in a straight line, forward or reverse. The X axis vectors represent the drivers R, L being driven in equal and opposite directions which has the effect of causing the mobility aid to spin in position in either a clockwise direction or a counter clockwise direction. Generally, the vectors above the X axis indicate that both drivers are being powered in the forward direction and the vectors below the X axis indicate that both drivers are being powered in the reverse direction, the exception being those vectors within transition sections A and B of FIG. 13. For joystick positions outside of transition sections A and B, the central processing unit 48 is programmed to smoothly and non-linearly shift the power ratio between the right and left drivers and adjust the speed of travel as the joystick is moved from position to position. Within sections A and B, the power ratio and direction of travel for each driver is linearly shifted by the central processing unit as graphically demonstrated in FIGS. 14A and 14B.

Viewing section A of FIG. 13 and FIG. 14A, when the joystick actuator is in the position that no power is delivered to the right driver (R=O) and the left driver is driven forward (L=FWD), the mobility aid will pivot around the right drive wheel in the clockwise direction. As the joystick actuator is moved toward the X-axis, the right driver begins to operate in the reverse direction at a linearly increasing speed and the left drive continues to operate in the forward direction, but at a linearly decreasing speed that generally parallels the right driver transition. As the joystick arrives at the X axis of section A, the left and right driver will operate in equal and opposite speeds, in effect causing the mobility aid to spin in a clockwise direction about its center point. Moving the joystick below the X axis continues the transition of motion of the mobility aid from forward drive to reverse drive. The left driver continues to linearly decrease in speed until it stops operation (L=O) and the right driver continues to linearly increase in speed in reverse (R=REV) so that the mobility aid is pivoting in the reverse clockwise direction about its left wheel. As the joystick continues in the reverse direction outside of transition section A, both right and left driver are operating in reverse in accordance with the power ratios as shown.

All movement of the joystick on the right side of the Y axis will result in the mobility aid moving in a clockwise direction generally in the same direction in which the joystick is pointing. All movement of the joystick to the left of the Y axis will likewise result in the mobility aid moving in a counter clockwise direction generally in the same direction in which the joystick is pointing. The power ratios on the left side of the Y axis in the same non-linear manner as described above with regard to motion in the clockwise direction when operating outside of the transition section B. The operation of the linear transition of power between drivers in transition section B is graphically demonstrated in FIG. 14B. The power transition between the left and right drivers is the same as described above with regard to transition section A.

Preferably, the CPU is programmed to provide certain enhanced safety characteristics to the operation and drive of the mobility aid. For instance, FIG. 15 presents a schematic representation of the velocity contours for joystick positioning. It is apparent that there are more contour lines in the forward direction than in the reverse direction; thus the mobility is programmed to operate at higher speeds in the forward direction than in the reverse direction. Likewise, it can be seen then the mobility and has a reduced speed curve as it makes sharper turns in the right or left direction. Such programmed velocity contours enable a smooth transition in the direction of travel, thereby providing greater safety and comfort for the operator. Further, in an effort to effect smooth stopping without jerkiness and sudden shifts in momentum that might prove harmful to the user, the CPU is programmed to provide for dynamic braking when the actuator is shifted to a slower speed level, a change in direction or the mobility aid is stopped. When such a change in operation is demanded, the CPU is programmed to reverse the pulse of current through a specific one or both of the drive motors to effect a gradual slowing of the mobility aid. Once the mobility aid reaches the condition where there is little or no current applied to the drive motors and the CPU senses that the mobility aid is almost in a stopped condition from signals received from the quadrature encoder tachometers 51A, 51B, the electric brakes 48A, 48B are engaged, after a momentary pause to safely lock the mobility aid in a fixed position.

The current flow for the operation of the mobility aid is preferably designed to be in the switched or pulsed mode and not in the linear mode as found in many prior art powered wheelchairs. Such prior art wheelchairs, operating in a linear mode, use a variable resistor to vary the power delivery to the drive motors in accordance with the position of the actuator joystick. If the wheelchair is driven at less than full power, the variable resistor acts to dissipate the power delivery and heat is given off as a by-product of such power dissipation. Excessive heat buildup can be dangerous to the operator and the stress on components caused by overheating is known to greatly reduce the operating life expectancy of the mobility aid. The pulsed or switched mode uses pulse width modulation of a fixed frequency current wherein the current is always at full power and is switched on and off for varying lengths of time within the fixed frequency to effect differing speeds of operation of the drive motors. The longer the span of time the pulse is on the faster the motor is driven. The longer the span of time the pulse is off, the slower the motor is driven.

Thus, by using the technique of pulse width modification to independently input power to each of the drive motors, extremely smooth operation and handling of the mobility aid is achieved with little power dissipation and little, if any, heat stress on the mobility aid components. By independently driving each motor through a combination of pulse width modification and dynamic braking the mobility aid is extremely versatile and can operate with a turning radius having a center point within the actual area occupied by the mobility aid. A smooth transition between forward, reverse, turning, high speed travel and low speed travel is achieved.

Furthermore, it is to be understood that although the present invention has been described with reference to a preferred embodiment, various modifications known to those skilled in the art may be made to the structures and operation presented herein without departing from the invention as recited in the several claims appended hereto.

I claim:

1. A powered mobility aid having a seat and a lock, the seat being engaged with a frame having a plurality of wheels and a power source engaged with at least two of the wheels for apply a driving force thereto, the power source comprising in combination:
a battery pack for supplying electrical power;
a central processing unit for creating signals controlling the driving force applied to each of the two wheels;
at least two motors receiving the signals from the central processing unit, each motor being independently operative and engaged with a respective wheel for providing an independent driving force to the respective wheel in accordance with the signals received from the central processing unit.

2. The powered mobility aid of claim 1 further including at least two brake members, each brake member being engaged with a specific motor and in combination with said central processing unit, wherein each of said brake members is activated upon receipt of a signal from said central processing unit that its respective motor is receiving no power input.

3. The powered mobility aid of claim 2 wherein each of said brake members is activated if the central, processing unit determines and signals that the mobility aid is not in motion or is moving at a predetermined slow rate.

4. The powered mobility aid of claim 1 further including at least two tachometers, each tachometer in communication with a specific motor for measuring the speed and direction of rotation of said motor and providing a signal to the central processing unit, whereby the central processing unit combines the signal received from each tachometer with the signal received from the actuator to develop a signal for each motor to drive said mobility aid as directed by the user.

5. The powered mobility aid of claim 4 wherein the central processing unit provides independent signals to each motor, each signal being the result of actuator position and signals received from the respective tachometer for each drive motor, to effectively drive the mobility aid in a desired direction by applying selectively different driving forces to each of said motors.

6. A process for operating a powered mobility aid comprising the steps of:
supplying electrical power to a central processing unit, drive motor, brake and actuator;
moving the actuator in a direction correlating to the direction in which the operator wishes to move, thereby creating a signal to the central processing unit;
creating a signal from each motor corresponding to the speed and direction of rotation of each motor and supplying that signal to the central processing unit; and
creating a specific drive signal to be sent to each independent motor in response to the signals received from the actuator and the motors, said drive signal being sent to each motor to control the speed and direction of rotation of the selected motor to create the speed and direction of movement of the mobility aid.

7. The operational process of claim 6 including continuously monitoring the speed and direction of movement of each motor and if the speed of each motor exceeds a predetermined limit, applying a reduced drive signal to said specific motor to slow the speed of the motor back within its predetermined limits.
